(19) United States
(12) Patent Application Publication
(10) Pub. No.: US 2009/0060453 A1
(43) Pub. Date: Mar. 5, 2009

(54) METHOD AND SYSTEM FOR AUTHORING MUSIC

(76) Inventor: John KELLOGG, Los Angeles, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/850,609

(22) Filed: Sep. 5, 2007

(51) Int. Cl. H04N 5/91

(52) U.S. Cl. 386/95

(57) ABSTRACT

The present invention provides a method for producing a music DVD disc that comprises categorizing downloading an audio content from a remote server, selecting the audio content for burning to the DVD disc, displaying an indication of an action that is to be performed to write the selected audio content to the DVD disc, and authoring the selected audio content to the DVD disc in response to the indicated action.

### TECHNICAL FIELD

The present invention relates to authoring a music disc, and more particularly, some embodiments relate to downloading and auto-authoring music files to a DVD disc.

### DESCRIPTION OF THE RELATED ART

Methods by which we purchase, store, and listen to music have greatly evolved during the last few decades. In the late 80s to early 90s, music CDs (compact discs) replaced the archaic compact cassettes, also referred to as audio cassettes or tapes. The audio content of audio cassettes is stored as an analog signal while the audio content of a CD is digitally stored. While many audiophiles prefer the sound reproduction offered by an analog storage medium, for most consumers, the digital media is more practical. With a high enough sampling rate and appropriate error correction algorithms, digital storage offers a cleaner sound quality over the noise prone analog counterpart.

The audio content of the CD is typically stored using 16-bit PCM (pulse code modulation) coding at a sampling rate of 44.1 kHz. In a music CD, PCM audio data are encoded for mono or a 2-channel stereo output. With the advent of advanced compression technologies and hardware affordability, multi-channel surround sound or high fidelity sound formats such as Dolby Digital® surround (AC3), MP3 Surround, and DTS® (digital theatre sound) have become widely available and are in great demand. For music lovers, regular fidelity formats such as AAC and MP3 are insufficient as they only deliver up to a 3-channel stereo music.

Delivering high-fidelity music to the public has proven to be difficult. High fidelity music formats typically require a very large data capacity, one that generally exceeds the capacity of a CD. Even though a CD may be able to store a couple of high fidelity songs, it would not be able to store a collection of songs encoded in a high fidelity format. Another obstacle is hardware compatibility. Millions of CD players have already been sold, and most are not compatible with high fidelity audio formats such as Dolby 5.1 and DTS 5.1, etc.

As mentioned, not only the way we listen to music has changed, but the way we store music has also changed. This is predominantly made possible with the availability of various compression technologies such as WMA (Windows Media Audio), AAC (Advanced Audio Coding) and MP3 (MPEG Audio Layer 3). Today, music data are stored in many forms of medium such as magnetic hard drives, flash memories, and CDs.

The method in which music is typically purchased has also undergone great transformation. Today, more music is being purchased through online music stores such as iTunes® and eMusic®. The majority of music sold is encoded in a non-high fidelity audio format such as AAC, MP3, and WMA. These formats typically trade off some level of audio quality to obtain file sizes that consume less bandwidth.

### BRIEF SUMMARY OF EMBODIMENTS OF THE INVENTION

The present invention is directed to methods, systems, and computer program products for producing a content medium such as, for example, an audio DVD disc. In one embodiment, the method comprises the steps of downloading an audio content from a remote server; selecting the audio content for burning to the DVD disc; displaying an indication of a single action that is to be performed to write the selected audio content to the DVD disc; and authoring the selected audio content to the DVD disc in response to the indicated single action. In another embodiment, the method further comprises the steps of: connecting to the remote server having a music library; selecting the audio content from the music library; downloading an image associated with the audio content from the remote server; and storing the audio content and the image in a memory device. In an embodiment, the audio content can be in a high fidelity format such as Dolby Digital or DTS.

In a further embodiment, the authoring step of the above method includes the step of: creating a navigational structure and a menu for the DVD disc; preparing a DVD compression format video file using the downloaded image or a pseudo image; preparing a DVD compression format audio file using the downloaded song; associating the DVD compression format audio file to the DVD compression format video file; and linking the DVD compression format audio and video files to the navigational structure and the menu such that both the audio and video files are automatically played when the DVD is inserted into a DVD player. The pseudo image may be a blank colored image or a collection of random images stored in a memory.

In another embodiment, the DVD compression format of the video file can be a MPEG-1 or a MPEG-2 format. Additionally, the DVD compression format of the audio file might be, for example, a Dolby Digital, a Linear PCM, or a DTS format.

In yet another embodiment, the DVD compression format video file is created using a plurality of images, and wherein the plurality of images are cycled through when the DVD is being played, thereby preventing a burn-in image in a displaying device.

In a further embodiment, the DVD disc is a high fidelity DVD disc such as, for example, a Blu-Ray disc or HD-DVD disc. Additionally, the DVD compression format of the video file might be a high fidelity compression format comprising a format from the group of MPEG-2, MPEG-4 AVC, and VC-1.

In a further embodiment, the DVD compression format of the audio file is a high fidelity compression format comprising one or more formats such as, for example, Dolby Digital, DTS, Dolby Digital Plus, DTS-HD High Resolution, Linear PCM, Dolby TrueHD, and DTS-HD Master Audio.

In yet another embodiment of the present invention, a method for creating a DVD disc having a music content comprises: downloading a song from a remote server; selecting the audio content for writing to the DVD disc; displaying the selected audio content on a write-to-DVD list; and authoring the selected audio content to the DVD disc in response to an instruction from a user.

In yet another embodiment of the present invention, a computer program product comprising a computer useable medium having computer readable program code functions embedded in said medium for causing a computer to create a music DVD disc is provided. The computer program product might be configured to include: a first computer readable program code that causes the computer to download a song from a remote server; a second computer readable program code that causes the computer to select the audio content for writing to the DVD disc; a third computer readable program code that causes the computer to display an indication of a single action that is to be performed to write the audio content to the DVD disc; and a fourth computer readable program code that causes the computer to author the audio content to the DVD disc in response to the indicated single action.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the figures listed below.

FIG. 1 illustrates an example environment in which the music portal can be implemented according to an embodiment of the present invention.

FIG. 2, which comprises FIGS. 2A, 2B and 2C, illustrates examples of user interfaces of the music portal according to embodiments of the present invention.

FIG. 3 illustrates an example a user interface of a setting window of the music portal according to an embodiment of the present invention.

FIG. 4 illustrates an example process flow implemented by the music portal according to an embodiment of the present invention.

FIG. 5 illustrates an example computer system in which the music portal can be implemented.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

1. Overview

Before describing the invention in detail, it is useful to describe an example environment in which the invention might be implemented. In one embodiment, the invention can be implemented using a computer program or other readable code running on a stand-alone computer, a networked computer system, a server or other processing device or system. The computer or computing system might be a personal computer, a laptop, or a mainframe, etc. The computer might include various input devices, such as a keyboard, mouse, trackball, etc.; various output devices, such as a monitor, printer, etc.; various communication ports such as network connections, USB ports, serial and parallel I/O ports, etc.; and various storage devices, such as ROM, RAM, disk drives, magnetic disks, magnetic tape drives, etc.

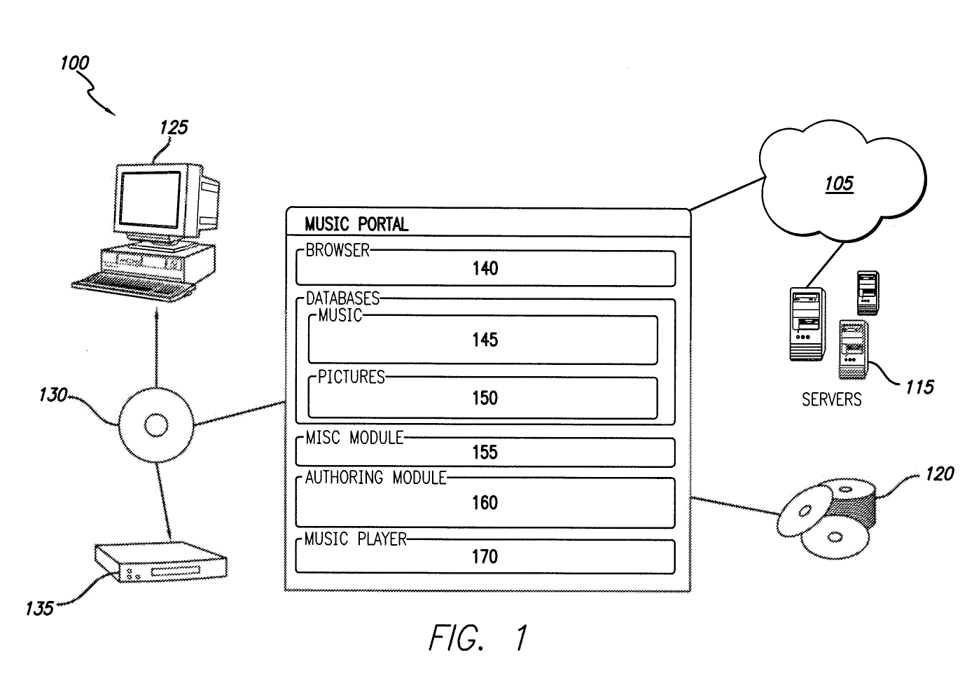

FIG. 1 illustrates an exemplary environment 100 in which the high fidelity music portal application (music portal) may be implemented in accordance with an embodiment of the present invention. Referring now to FIG. 1, environment 100 includes a network 105, a music portal 110, server 115, a music collection 120, a computer 125, a DVD or a high fidelity DVD disk 130, and a DVD or high fidelity DVD player 135. Network 105 can be the internet, a local area network (LAN), a wide area network (WAN), a plain old telephone system (POTS), or any other suitable network. Music portal 110 may reside on a computer or a server. Music portal 110 may be operated directly on the computer/server on which it resides. Alternatively, music portal may be a web-based application that allows users to operate it remotely.

In one embodiment, music portal 110 includes a web browser module 140, a music database 145, an image database 150, a management module 155, an authoring module 160 and a music player 170. In one embodiment, browser module 140 enables music portal 110 to be connected with an online music store such as music store 115. In one embodiment, music database 145 is used to store imported and downloaded music files from online store 115 or other external sources. According to one embodiment, management module 155 is configured to assist a user in purchasing and downloading music, keeping track of favorites, creating customized libraries and playlists, etc. Authoring module 160 might also be configured to create or burn music files into a CD, DVD, HD-DVD, or Blu-Ray disc according to various embodiments of the present invention.

Music player 170 might be configured to allow the user to listen to songs in music database 145. In one embodiment, music player 170 is configured to playback a variety of music formats such as, for example, AC3, MP3, WMA, DTS, and PCM.

Disk 130 is created in one embodiment using music portal 110. When a user wants to listen to high fidelity music, the user may use music portal 110 to create disk 130. This includes, but not limited to, multi-channel music formats such as 5.1 and 7.1 surround sound system. Disk 130 may be a CD, DVD disc, a HD-DVD disc, or a Blu-Ray disc. Hereinafter, HD-DVD discs, Blu-Ray discs, and any other high definition disc standard having a higher fidelity than standard DVD discs will be collectively referred to as “high fidelity DVD” discs. Once disk 130 is authored by music portal 110, it can be played using computer 125 or a DVD-Video player 135, assuming the burned disc is a DVD-Video disc. Most computers and laptops have the ability to playback DVD-Video disc. DVD-Video players are also ubiquitous. As a result, music portal 110 can be implemented to allow the user to customize and create a DVD-Video disc containing high fidelity music or a combination of high fidelity and non-high fidelity music and will be able to listen to the created disc practically anywhere. As mentioned, music portal 110 also has the capability to create customized music disc using high fidelity DVD discs. In this way, when HD-DVD and Blu-Ray players become abundant, the user will have the ability to listen to high fidelity music using such high fidelity DVD disc players.

Music portal 110 may obtain music in several ways. In one embodiment, music is downloaded from server 115, which may contain both high-fidelity and non-high-fidelity music. Music may also be imported into music portal 110 from music collection 120, which may be a storage device having MP3, AAC, and/or WMA music files. Music collection 120 may also be a collection of music CDs.

In one embodiment, server 115 is an online music store that can be accessed using a web browser or with music portal 110. Server 115 is similar to online services like iTunes® and eMusic®; however, server 115 also offers music in high fidelity formats. Server 115 may offer music in a variety of high fidelity formats such as, but not limited to, Dolby Digital and DTS. Additionally, server 115 may sell music singly as individual title or in bulk as in an album in high fidelity formats, which may come as an image file. In this way, the user may customize her music collection and create a music disc having high fidelity music.

2.0 Music Portal

As mentioned, the way we typically purchase music has changed dramatically. Today, more music is being purchased through online music stores such as iTunes® and eMusic®. Practically, all of the music sold online is encoded in a non-high fidelity audio format such as AAC, MP3, and WMA. Traditional online music stores do not offer music in high fidelity formats largely because consumers would not be able to listen to it nor burn it to a DVD disc for playback in a DVD-Video player. This presents a two-prong problem for audiophiles. First, high fidelity music is not widely available and cannot be easily purchased. Even if one can be purchased, there is no means to listen to it or to customize a high fidelity music disc for everyday use. In one embodiment, music portal 110 provides the ability for a user to download, listen to and customize high fidelity audio files such as AC3 and DTS files for example.

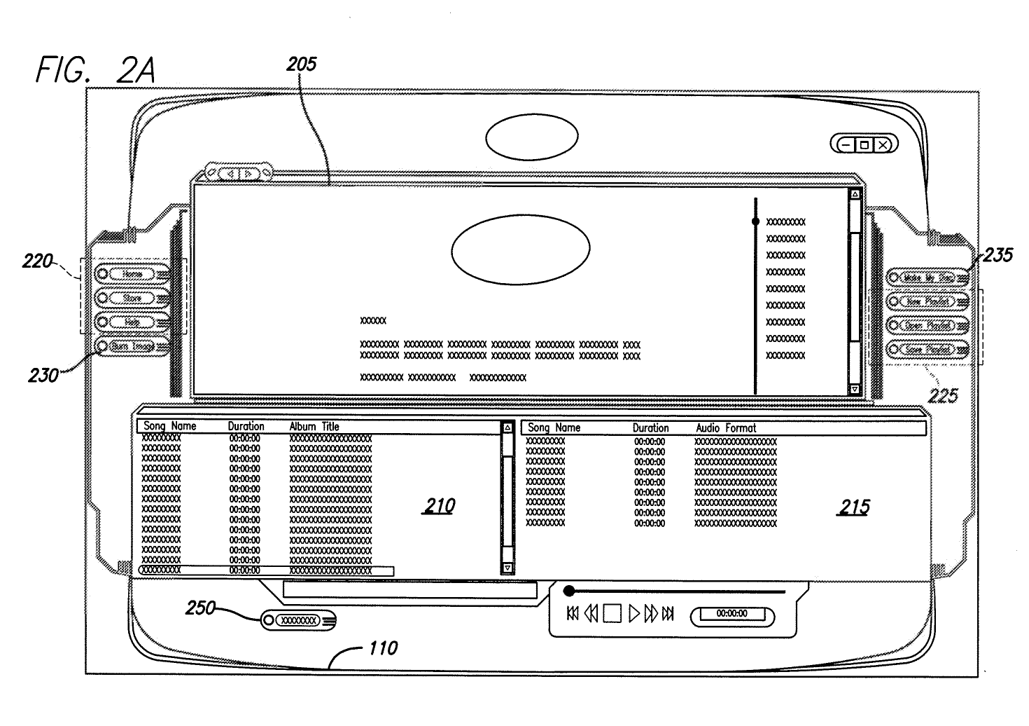

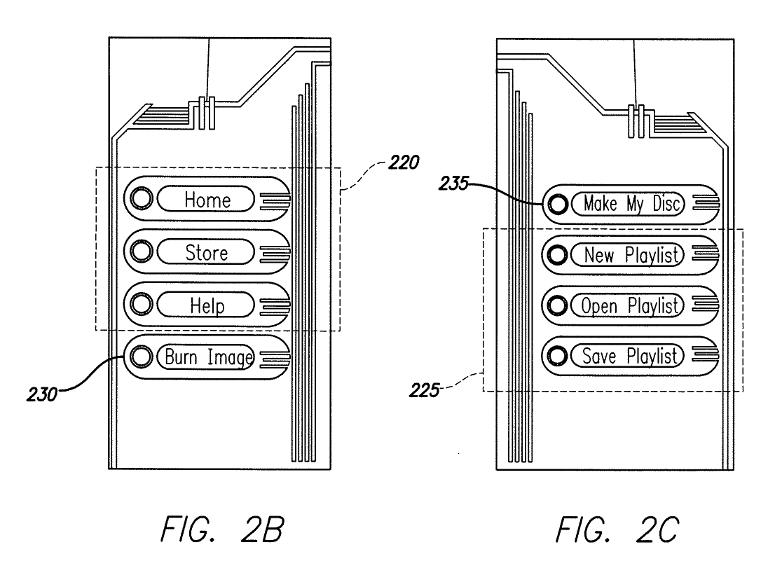

FIG. 2A is a pictorial illustration of music portal 110 according to an embodiment of the present invention. Referring to FIG. 2A, music portal 110 includes a browser 205, a library window 210, a playlist window 215, a browser navigation interface 220, a playlist management interface 225, a ‘burn image’ button 230, and a ‘create my disc’ button 235.

Music portal 110 can be operated in various modes such as, for example, an offline or an online mode. In one embodiment, in online mode, music portal 110 automatically connects to music store or server 115 when the portal is opened. Once connection is established with music store 115, the music store's interface is displayed on browser 205. In one embodiment, browser 205 is “hard wired” to the IP address of music store 115, although other store or multiple stores can be concurrently accessed. In this way, the user may browse online music store 115 through music portal 110. While at online store 115, the user may do the following: browse and purchase products such as, but not limited to, physical CD, merchandise and online music; perform research on artists and media featured; and listen to and view samples of the artists work (music and video).

The user may interact with the online store by clicking on links provided in the content of browser 205. The user may also use navigation interface 220 to navigate through online website. FIG. 2B illustrates an example of an interface 220 according to one embodiment. Additionally, the user can purchase and download music by dragging and dropping an audio file from online store 115 to library window 210. The user may also drag and drop audio files from library window 210 and playlist window 215.

When a music file is purchased and downloaded, the music file can be stored in local music database 130. Online music store 115 may also have an image associated with the music file purchased. Music portal 110 is also configured to download this image file and store it in image database 150. In an embodiment, music store 115 may contain a collection of images for an individual song, a label, or an album. This collection of images may be separately purchased or be included with a sale of the audio content, label or album.

In offline mode, in one embodiment, library window 210 can be configured to list some or all of the audio content available locally. The search for local audio content may be automatically performed or manually performed by a user. Alternatively, library window 210 can be configured to display a user-defined directory where audio content is located. Library window 210 may display information such as, for example, the name of the file or song, the duration of the audio content, the audio format of the audio content, the artist, and the name of the album. Once a song is purchased and downloaded from online store 115, music portal 110 may display it in library window 210. Whether a newly downloaded song appears in library window 210 depends in one embodiment on the settings applied by the user.

From library window 210, the user may select one or more songs to be played or burned. When a song in the library is selected by the user, the selected audio content appears in playlist window 215. Using music portal 110, the user may playback songs listed in playlist 215. In one embodiment, music portal 110 is configured to playback audio files being formatted with any of the following formats AAC, MP3, WMA, AC3, DTS, and PCM. The user may also use playlist window 215 to create a user-defined playlist for listening or for burning to a disc. The user may use playlist interface 225 to create a new playlist, open a previously saved playlist and save a playlist. Interface 225 is shown in more detail in FIG. 2C.

Burn-image button 230, as shown in the example illustrated in FIG. 2B, is configured to burn an entire disc image with a single click according to one embodiment of the invention. As mentioned, online music store 115 may sell an entire album on a single image file. This image file may contain regular-fidelity or high-fidelity songs. Once the image file is purchased, downloaded and stored in local music library database 130, the image file can then be burned to a CD or DVD or other medium, depending on the fidelity of the music files. In one embodiment, this can be performed with just a single click.

Make My Disc button 235, as shown in FIG. 2C, is similar to Burn Image button 230. Button 235 performs essentially the same function as button 230, however, it is generally used for making customized discs using playlist 215. Preferably, the interface is implemented such that a single click of button 230 or button 235 causes the application to perform a series of scripted processes where the files are automatically integrated into a high fidelity architecture and disc image, which is then burned on to a blank high fidelity disc or other medium. For example, it might be integrated into a DVD-R architecture and burned to a DVD disk.

The resulting medium can have standard navigating menus generated by music portal's 110 authoring module 160, which are discussed in further detail below. In one embodiment, authoring module 160 generates either a “black screen” or a custom graphics containing a single or a plurality of images for each track on the disc. The custom graphics for each track can be bundled as part of the downloaded “album” or individually as part of the audio file download. In this way, the DVD disc authored by music portal 110 is compatible with most or all of the standard DVD-Video players. This may, for example, allow the user to playback and enjoy the music in high fidelity.

As previously mentioned, in one embodiment, music player 170 is configured to output the audio to various devices such as, but not limited, internal computer speakers, external surround sound speakers, or wirelessly using 802.11g, Bluetooth, or other suitable wireless standards.

Typically, the internal speakers of a computer are not capable of playing high fidelity surround sound. Thus, if the files in playlist 215 are in high fidelity format, then during playing back music player 170 is configured to down convert the signal and play the audio in stereo or other format compatible with the computer system. However, if the user's sound card supports 5.1 channel output (or other high-fidelity output), then music player 170 may output the audio in stereo such 5.1 or other high-fidelity format.

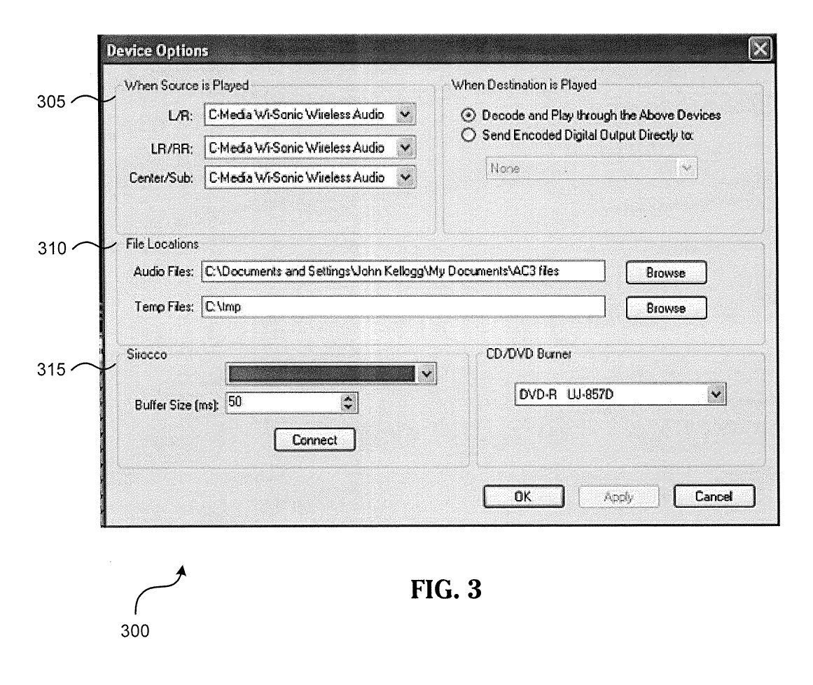

FIG. 3 illustrates an interface 300 that allows the user to set various operational settings of music portal 110 according to one embodiment. In the example illustrated in FIG. 3, interface 300 includes a portion 305 for setting audio output options, a portion 310 for setting a library source, and a portion 315 for selecting a wireless output device. Portion 305 is configured to allow the user to select which speakers or speaker system to use for audio playback. Portion 310 allows the user to identify the folder containing music files to be listed in library window 210. Portion 315 allows the user to specify which wireless speaker devices music player should 170 select as the output device such as, for example, a Sirocco wireless music router. In an embodiment, the audio is outputted to the Sirocco router using 802.11g.

2.1 Music Portal's Authoring Application

In one embodiment, authoring module 160 is configured to create or burn music files into a CD, DVD, HD-DVD, Blu-Ray or other format. For example, authoring module 160 might be configured to burn music files into a CD disc if the music files in playlist 215 are regular fidelity or non-high fidelity music files. High fidelity music files are preferably not burned to a CD disc because they usually cannot be played by ordinary CD players. Similarly, authoring module 160 might configured to burn high definition music files to a DVD disc or to a high fidelity disc such as, for example, HD-DVD and Blu-Ray.

In one embodiment, music portal 110 might be implemented to provide the DVD authoring process for the user to a single click of a button. Once the user has populated playlist 215 with songs to be burned, the authoring process may begin with just a click of button 235.

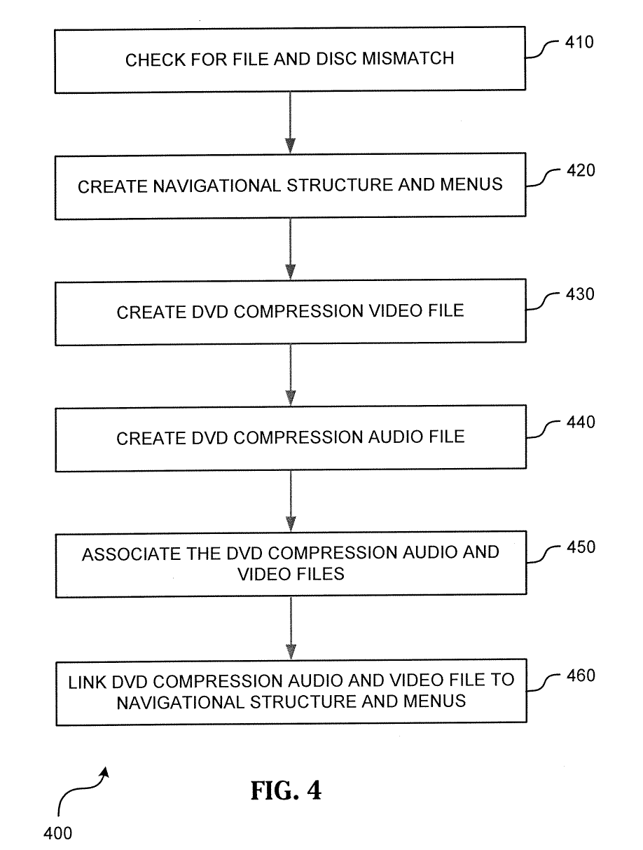

FIG. 4 illustrates an authoring process 400 implemented by authoring module 160 according to an embodiment of the present invention. Referring now to FIG. 4, authoring process 400 starts at a step 410 in which authoring module 160 checks to see if the correct medium is present. For example, authoring module 160 might be configured to check to see whether a correct disc is inserted into the CD/DVD burner and whether the correct music file format is selected. In one embodiment, authoring module 160 is configured to generate an error message for the following scenarios: the music files to be burned are all in high fidelity format and a CD disc is inserted; the music files to be burned are all in non-high fidelity format and a DVD disc or a high fidelity DVD disc is inserted; and the music files to be burned are a mixed of high fidelity and non-high fidelity music files, regardless of the disc inserted.

In one embodiment, the authoring process 400 is automatically performed after the user clicks on Make My Disc button 235. For example, once the user clicks button 235, and assuming a proper disc is in the burner, disc 130 is generated without further input from the user.

Steps 420-460 described below are used to create a music DVD-Video disc according to an embodiment of the present invention. In a step 420, authoring module 160 creates a navigational structure in DVD-Video format. In this step, the general menu structure of the DVD is defined.

In a step 430, authoring module 160 creates a DVD compression video file. In one embodiment, a blank DVD compression format video file is created using a colored background such as, for example, black or white. Alternatively, the video file is created using an image from image database 150. As mentioned, the image may be downloaded from online music store 115. The image may or may not be relevant to the music file. In one embodiment, the DVD compression video file is created using a plurality of images from database 150 or from an external source. Authoring module 160 may cycle through a collection of images at random interval. In this way, the user may watch the image or a slideshow while listening to music. In an embodiment, the DVD compression video format is MPEG1 or MPEG2.

In a step 440, authoring module 160 creates a DVD compression format audio file from the high fidelity music file or files listed on playlist 215. In one embodiment, authoring module 160 creates a DVD compression audio format file that is compatible for playback in a DVD-Video player. In one embodiment, the DVD compression audio format can be, for example, Dolby Digital, Linear PCM, or DTS. To do this, in an embodiment, the source audio file must also be in a high fidelity format such as, for example, AC3, DTS, or PCM.

In a step 450, the created DVD compression audio file is associated the DVD compression video file. In this way, when the video file is played, the audio file will also be played. Although we discuss in terms of DVD and particular format DVDs, one of ordinary skill in the art would understand after reading this disclosure that other media could be used.

In a step 460, authoring module 460 links the DVD compression video and audio files created in steps 430-440 to the navigational structure such that both the audio and video files are preferably played automatically when the DVD disc is inserted into a DVD-Video player.

In one embodiment, the process for authoring an HD-DVD or Blu-Ray music disc is similar. In an embodiment, an HD-DVD or Blu-Ray music disc is also created using steps 320-360. However, the DVD compression video format used to create high fidelity DVD disc might be a different format such as, for example, MPEG-2, MPEG-4 AVC, or VC-1. The DVD compression audio format used to create high fidelity DVD disc may be, for example, Dolby Digital, DTS, Dolby Digital Plus, DTS-HD High Resolution, Linear PCM, Dolby TrueHD, and DTS-HD Master Audio. One skilled in the art would understand that one or more combinations of video and audio formats can be used to create a playable HD-DVD or Blu-Ray disc.

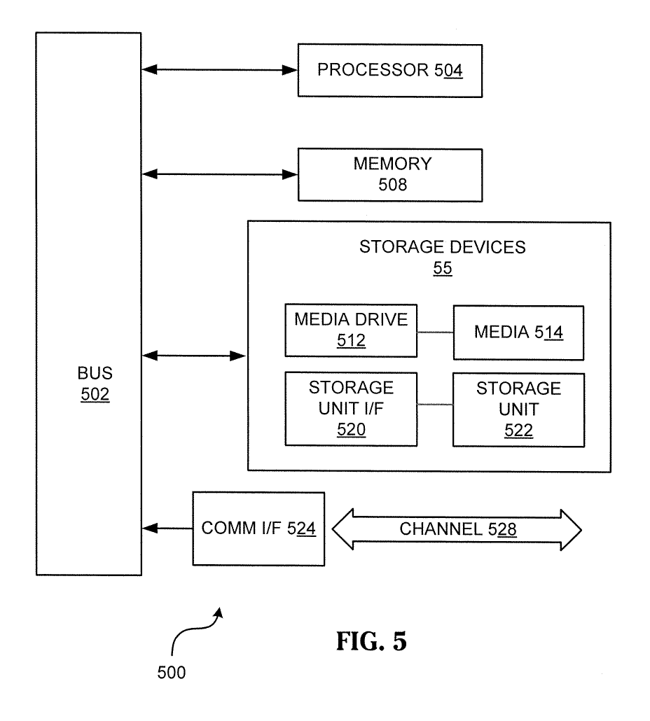

The term tool can be used to refer to any apparatus configured to perform a recited function. Tools can include a collection of one or more modules and can also be comprised of hardware, software or a combination thereof. Thus, for example, a tool can be a collection of software modules, hardware modules, software/hardware modules or any combination or permutation thereof. As another example, a tool can be a computing device or other appliance on which software runs or in which hardware is implemented.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special or general purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, modems, routers, WAPs, and any other electronic device that might include some form or processing capabilities.

Computing module 500 might include one or more processors or processing devices, such as a processor 504. Processor 504 might be implemented using a general-purpose or special-purpose processing engine such as, for example, a microprocessor, controller, or other control logic. In the example illustrated in FIG. 5, processor 504 is connected to a bus 502 or other communication medium to facilitate interaction with other components of computing module 500.

Computing module 500 might also include one or more memory modules, referred to as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive. Accordingly, storage media 514, might include, for example, a hard disk, a floppy disk, magnetic tape, optical disk, a CD or DVD, or other fixed or removable medium that is read by, written to or accessed by media drive 512. As these examples illustrate, the storage media 514 can include a computer usable storage medium having stored therein particular computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, 802.XX or other interface), a communications port (such as for example, a USB port, IR port, RS232 port Bluetooth interface, or other port), or other communications interface. Software and data transferred via communications interface 524 might typically be carried on signals, which can be electronic, electromagnetic, optical or other signals capable of being exchanged by a given communications interface 524. These signals might be provided to communications interface 524 via a channel 528. This channel 528 might carry signals and might be implemented using a wired or wireless medium. Some examples of a channel might include a phone line, a cellular phone link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and signals on channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for producing an audio DVD disc comprising:
downloading an audio content item from a remote server;
selecting the audio content item for burning to the DVD disc;
displaying an indication of an action that is to be performed to write the selected audio content to the DVD disc; and
authoring the selected audio content to the DVD disc in response to the indicated action.

2. The method of claim 1, further comprising:
connecting to the remote server having a music library;
selecting the audio content from the music library;
downloading an image associated with the audio content from the remote server; and
storing the audio content and the image in a memory device.

3. The method of claim 1, wherein the audio content is in a high fidelity format.

4. The method of claim 2, wherein the authoring step comprises:
creating a navigational structure for the DVD disc;
preparing a DVD compression format video file using the downloaded image or a pseudo image;
preparing a DVD compression format audio file using the downloaded song;
associating the DVD compression format audio file to the DVD compression format video file; and
linking the DVD compression format audio and video files to the navigational structure such that both the audio and video files are automatically played when the DVD is inserted into a DVD-Video player.

5. The method of claim 5, wherein the pseudo image is a blank colored image or a collection of random images stored in a memory.

6. The method of claim 5, wherein the DVD compression format of the video file is MPEG-1 or MPEG-2.

7. The method of claim 5, wherein the DVD compression format of the audio file is Dolby Digital, Linear PCM, or DTS.

8. The method of claim 5, wherein the DVD compression format video file is created using a plurality of images, and wherein the plurality of images are cycled through when the DVD is being played, whereby preventing a burn-in image in a displaying device.

9. The method of claim 1, wherein the DVD disc is a high fidelity DVD disc.

10. The method of claim 9, wherein the high fidelity DVD is a Blu-Ray or HD-DVD disc.

11. The method of claim 10, wherein the DVD compression format of the video file is a high fidelity compression format consisting of a format from the group of MPEG-2, MPEG-4 AVC, and VC-1.

12. The method of claim 5, wherein the DVD compression format of the audio file is a high fidelity compression format consisting of one or more formats from the group of Dolby Digital, DTS, Dolby Digital Plus, DTS-HD High Resolution, Linear PCM, Dolby TrueHD, and DTS-HD Master Audio.

13. A method for creating a DVD disc having a music content comprising:
downloading an audio content from a remote server;
selecting the audio content for writing to the DVD disc;
displaying the selected audio content on a write-to-DVD list; and
authoring the selected audio content to the DVD disc in response to an instruction from a user.

14. The method of claim 13, wherein the authoring step comprises:
creating a navigational structure and a menu for the DVD disc;
preparing a DVD compression format video file using the downloaded image or a pseudo image;
preparing a DVD compression format audio file using the downloaded song;
associating the DVD compression format audio file to the DVD compression format video file; and
linking the DVD compression format audio and video files to the navigational structure and the menu such that both the audio and video files are played when the DVD is inserted into a DVD-Video player.

15. A computer program product comprising a computer useable medium having computer readable program code functions embedded in said medium for causing a computer to create a music DVD disc comprising:
a first computer readable program code that causes the computer to download an audio content from a remote server;
a second computer readable program code that causes the computer to select the audio content for writing to the DVD disc;
a third computer readable program code that causes the computer to display the selected audio content on a write-to-DVD list; and
a fourth computer readable program code that causes the computer to author the selected audio content to the DVD disc in response to an instruction from a user.

16. The computer program product of claim 15, wherein the fourth computer code comprises instructions for the computer to:
create a navigational structure and a menu for the DVD disc;
create a DVD compression format video file using the downloaded image or a pseudo image;
create a DVD compression format audio file using the downloaded song;
associate the DVD compression format audio file to the DVD compression format video file; and
link the DVD compression format audio and video files to the navigational structure and the menu such that both the audio and video files are played when the DVD is inserted into a DVD-Video player.

17. The computer program product of claim 16, wherein the DVD compression format of the video file is MPEG-1 or MPEG-2.

18. The computer program product of claim 16, wherein the DVD compression format of the audio file is Dolby Digital, Linear PCM, or DTS.

19. The computer program product of claim 16, wherein the DVD compression format video file is created using a plurality of images, and wherein the plurality of images are cycled through when the DVD is being played.

20. The computer program product of claim 15, wherein the DVD disc is a high fidelity DVD disc.

21. The computer program product of claim 20, wherein the high fidelity DVD is a Blu-Ray or HD-DVD disc.

22. The computer program product of claim 21, wherein the DVD compression format of the video file is a high fidelity compression format consisting of a format from the group of MPEG-2, MPEG-4 AVC, and VC-1.

23. The computer program product of claim 21, wherein the DVD compression format of the audio file is a high fidelity compression format consisting of one or more formats from the group of Dolby Digital, DTS, Dolby Digital Plus, DTS-HD High Resolution, Linear PCM, Dolby TrueHD, and DTS-HD Master Audio.
